(19) United States
(12) Patent Application Publication
(10) Pub. No.: US 2011/0103044 A1
(43) Pub. Date: May 5, 2011

(54) Modular Barrier For Enclosures And Signage

(75) Inventor: Alvaro Quintanilla I Gonzalez, Barcelona (ES)

(73) Assignee: ACEFHAT, A.I.E., Barcelona (ES)

(21) Appl. No.: 11/630,148

(22) PCT Filed: May 4, 2005
(86) PCT No.: PCT/ES2005/000240

§ 371 Date: Sep. 3, 2008

(30) Foreign Application Priority Data
Jun. 30, 2004 (ES) U 200401608

(51) Int. Cl. E04H 17/18; F21S 8/00

(52) U.S. Cl. 362/152; 256/25; 256/19

(57) ABSTRACT

The present invention relates to a modular fence for enclosures and signs, preferably made of a plastic material and indistinctly usable both indoors and outdoors, offering an optimal degree of stability, being easily stackable when inoperative and in turn being easily coupled to other modules or fences used in the enclosure or signs. The fence has an essentially planar vertical face oriented towards the pedestrian sidewalk area, preventing obstacles that could be the cause of accidents, and is provided with a lighting system facilitating both seeing the fence io itself and drawing the attention of the pedestrians to the information or advertisement borne thereon.

### OBJECT OF THE INVENTION

The present invention relates to a fence envisaged as a module for obtaining enclosures, indications, road signs or other similar provisions.

### BACKGROUND OF THE INVENTION

In the scope of the practical application of the invention modular fences are known which are essentially obtained from a plastic material and have broad and varied drawbacks, focused mainly on the following aspects:
They have elements projecting on the pedestrian sidewalk, obstructing said walk and possibly creating drawbacks or minor accidents in the passage of said pedestrians.
They generally incorporate metallic parts to reinforce their structure and support the stresses to which they must be subjected.
Due to the incorporation of built-in metallic members, they usually undergo permanent straining as they are subjected to certain stresses.
The linking systems between fences are generally limited in overcoming obstacles or in adapting to inclinations of the terrain, making it difficult for the various fences or modules to remain linked together.
They are provided with four support points, making their positioning unstable when they are arranged on uneven surfaces, like they normally are.
They do not allow being stacked when they are inoperative, which quite considerably increases the space they occupy in the storage and transport thereof.

### DESCRIPTION OF THE INVENTION

The fence proposed by the invention resolves in a fully satisfactory manner the drawbacks previously set forth in the different aspects discussed.

The object of the invention is to achieve a light and resistant fence made exclusively of a plastic material, that can be used indistinctly both indoors and outdoors, offering an optimal degree of stability, being easily stacked when inoperative, in turn being easily coupled with other modules or fences used in the enclosure or signs, having an essentially planar and vertical surface oriented towards the pedestrian sidewalk area, preventing obstacles which could be the cause of accidents and having a lighting system which aids in seeing the fence itself as well as drawing the attention of the pedestrians to the information or the advertisement borne on said fence.

To that end and more specifically, said fence will consist of two parts preferably obtained by means of injection molding, intended for being fixed to one another in a freely detachable manner along their top edge by means of tongue and grooving and with the aid of attachment bolts, also of a plastic material, forming an inverted V-shaped profile with asymmetrical branches, one of them being considerably shorter than the other one, such that when resting on the ground, the shorter part takes on a vertical arrangement, with no elements projecting towards the corresponding outer face.

This vertical part has an essentially rectangular contour, a mesh structure so as to lighten its weight, and two bottom legs extending in supports towards its outer face, enhancing the stability of the fence as a whole, whereas the inclined part takes on an inverted isosceles trapezium shape, defining the third support leg of the assembly, this second part also having a mesh structure for the same purpose.

For the purpose of enhancing the stability in the fixed attachment between both parts, it has been provided that one of them, preferably the inclined one, incorporates a wide triangular bracket on one of its side edges arranged as a spacing element and attachment means with respect to the other part, preventing the straining of the inverted dihedron formed by said parts.

The spacing between the two legs which one of the parts is provided with and the leg formed by the second part make the fence perfectly stable against wind stresses, its mesh structure also aiding in this task by allowing the free passage of the wind through the fence body.

As a supplement of the described structure and for attachment between fences or modules, it has been provided that the vertical part incorporates on one of its edges a pair of resilient clamps substantially offset from one another in height, and there is a supplementary bar for these clamps located on its opposite edge duly spaced form the part itself, such that said clamps can be fixed to the bar of the next module at any height needed, which allows overcoming unevenness in the terrain, such as large steps. At the same time it has been provided that said parts form a considerably open housing on said bar, which in turn allows for different inclinations in two adjacent fences or modules.

The dihedral configuration of the fence allows for stacking of the fences, substantially fitting some fences in others, which minimizes the space they occupy when in storage or transport. To facilitate their stacking and the extraction of the fences, the latter have a horizontal projection on the outer sides of the two parts forming the fence. When one fence is stacked on another, the legs of the front part of the stacked fence will rest on the horizontal projection of the front part of the bottom fence, and the same occurs with the support leg of the back part.

According to another feature of the invention, it has been provided that there is arranged on the top crosspiece of one of said parts, preferably of the part taking on the vertical position, a small housing for at least one, preferably two, standard long-lasting batteries, which housing is obviously accessible for maintenance of said batteries feeding a lighting device, preferably a light emitting diode or LED, or LED groups, fitted in a small port of the outer wall of the repeatedly mentioned housing. Said lighting device incorporates a sensor which switches off the light in the event that there is sufficient ambient light, such that the lighting device only acts when there is no or very little ambient light.

Said lighting device consists of different elements which allow their incorporation to the fence, such as a front diffuser, a back cover for fixing an electronic board controlling the lighting device and a front seal protecting the different electrical or electronic components from external factors. These components make the lighting device impossible to disassemble by non-authorized personnel and tight against external agents of any type once it is incorporated in its corresponding housing in the fence.

The surfaces of the fence that are not closed can be used as a support for any type of fixed or removable signage and/or signs, including reflective or retroreflective signs.

### DESCRIPTION OF THE DRAWINGS

To complement the description being made and for the purpose of aiding in understanding the features of the invention, according to a preferred practical embodiment thereof, a set of drawings is attached as an integral part of said description, in which the following is shown with an illustrative and non-limiting character:

FIG. 1 shows an exploded perspective view of a modular fence for enclosures and signs carried out according to the object of the present invention.

FIG. 2 also shows a perspective view of the same fence of the previous figure with its two parts duly assembly.

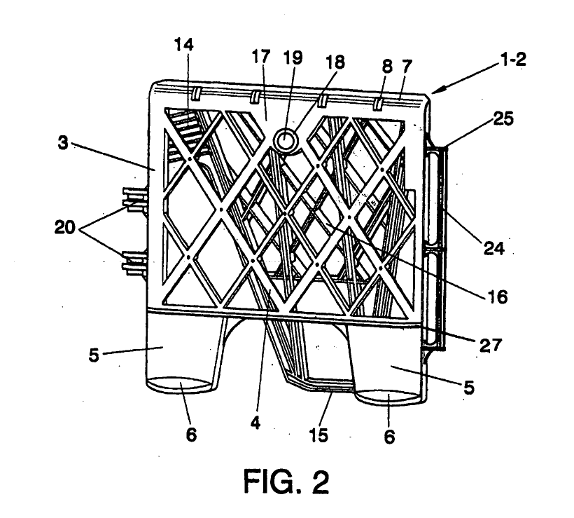

FIG. 3 shows a front elevational view of the same fence.

FIG. 4 shows a plan view of a detail of one of the attachment clamps between fences.

FIGS. 5 and 6 show respective schematic depictions of the coupling between fences or modules on irregular surfaces, specifically on surfaces with steps and on uneven surfaces.

Finally, FIG. 7 shows a profile view of a detail of the coupling between two modular fences.

### PREFERRED EMBODIMENT OF THE INVENTION

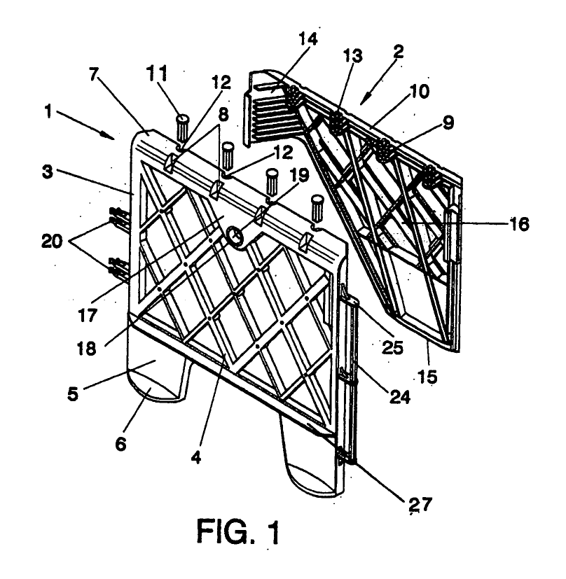

In view of the discussed figures, particularly FIG. 1, it can be seen how the fence proposed by the invention is formed by two parts, a front part 1 and a back part 2, which are initially separate but intended to be fixed together in a non-permanent manner, i.e. they can be disassembled, which parts are preferably obtained by means of plastic injection molding, one of which parts, the front part 1, forms a type of rectangular frame 3 enclosing a highly resistant and lightweight mesh structure 4 further forming a minimum barrier for the passage of air, said frame 3 extending at its bottom area into a pair of end legs 5 with external bottom projections 6 so as to enhance its stability, whereas transverse housings 8 are arranged on its top crosspiece 7 for the tongue and groove coupling of supplementary elements 9 projecting from the top edge 10 of the other part or back part 2, these elements finally being locked together by means of bolts 11, also preferably made of plastic, simultaneously traversing openings 12 of crosspiece 7 of part 1 and openings 13 of top crosspiece 10 of part 2.

When the front part 1 and back part 2 are assembled, they form an acute dihedron in which the front part 1 takes on a vertical arrangement whereas the back part 2 takes on an inclined arrangement due to its greater length, as seen in FIG. 7, and said dihedron is stiffened by the existence, preferably on the back part 2 next to the top end of at least one of its side edges, of a bracket 14 oriented towards the front part 1 and duly fixed to the latter.

The back part 2 takes on a general inverted isosceles trapezium shape such that its bottom edge 15 forms the third leg of the fence, and it also has a mesh structure 16 similar to the previously mentioned structure 4 for the same purpose of maximizing structural rigidity with the smallest weight and with large ports for the passage of air.

The described structure is complemented with at least one small housing 17 defined under the top crosspiece 7 of front part 1 with at least one port 18 in which there is housed at least one lighting element 19, or preferably an LED or an LED diode group, fed by a long-lasting battery or group of batteries preferably housed in said housing 17.

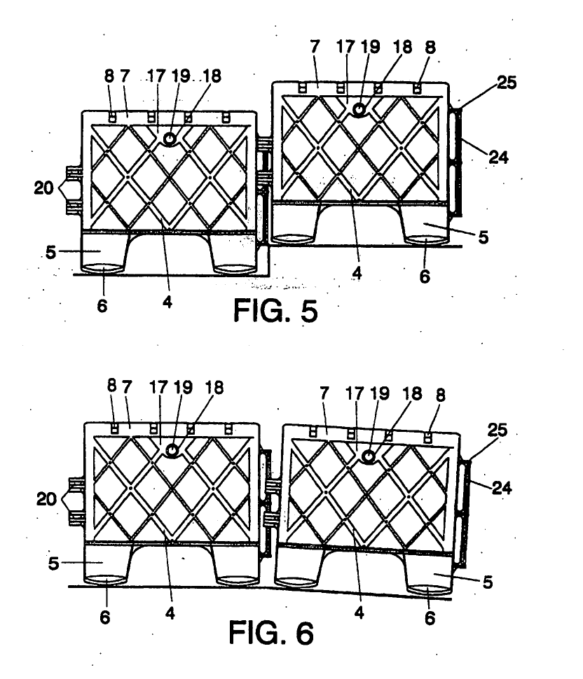

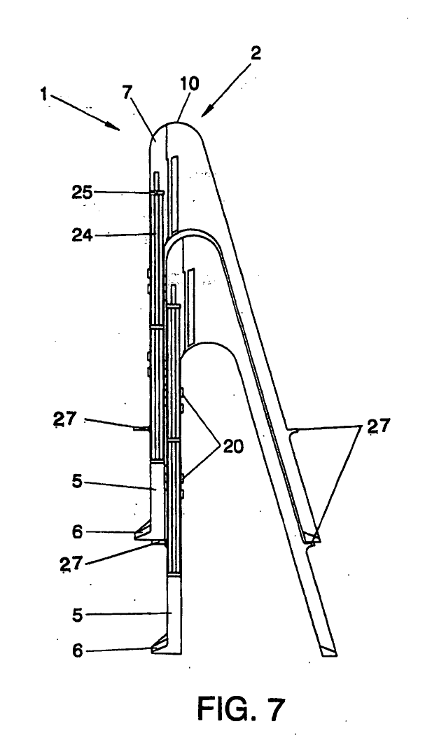

For the coupling between fences or modules, the front part 1 incorporates on one of its side edges at least one clamp 20 represented in detail in FIG. 4, with two resilient arms 21 defining a slotted housing 22 with a tapered opening 23, these clamps being snapped onto a bar 24 of considerable height, duly fixed to the opposing edge of the front part 1 and separated from said part by means of spacers 25. As can be seen in FIG. 5, the length of this bar 24 allows modules or fences to be considerably offset in height given the existence of steps on the ground, while at the same time the slotted housings 22 of the clamps 20 allow adjacent fences to be suitably fixed together and stabilized on irregular supporting surfaces, as shown in FIG. 6.

On the other hand, and as is also shown in FIG. 7, the dihedral shape and the completely open interior of the fence allow stacking with other identical fences, taking up minimum space. The fences have a horizontal projection 27 on each one of the outer faces of the two parts 1, 2 forming the fence. When one fence is stacked on another, the legs 5 and their supports 6 of the front part 1 of the stacked fence will rest on the horizontal projection 27 of the front part 1 of the bottom fence, and this also occurs with the support leg of the back part 2 of the stacked fence, which will rest on the horizontal projection 27 of the back part 2 of the fence located on the bottom of the front one.

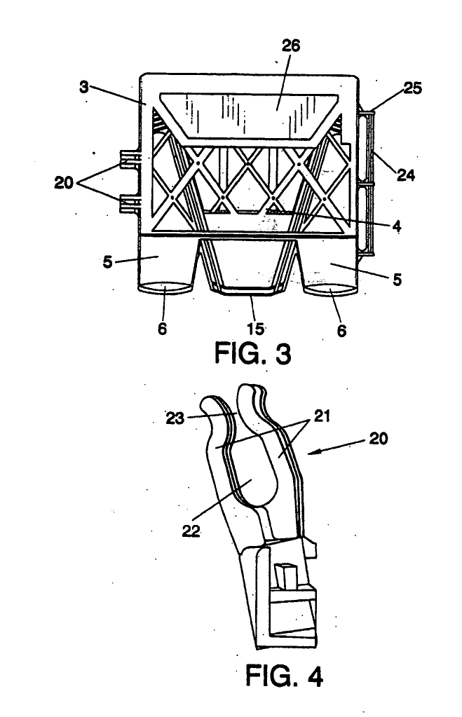

It must finally be indicated that the enclosed areas of the fence can be used for placing signs thereon, such as the area with reference number 26 in FIG. 3, for example.

1. A modular fence for enclosures and signs, of the type comprising two separate parts, a vertical front part, with two projections extending at its bottom area into a pair of legs, and a back part, defining a unique centered leg, inclined with respect to the front part and which are detachably fixed together, characterized in that at least one of said parts incorporates on its top crosspiece, in correspondence with its edge that is hingedly linked to the other part, at least one transverse housing for the tongue and grooved coupling of complementary projections emerging from the top edge of the other part, while at the same time on the crosspieces of both parts there are opposing vertical openings for the passage of respective attachment bolts for attaching the parts.

2. The modular fence according to claim 1, wherein at least one of said parts incorporates on the top end of at least one of its side edges a bracket bent orthogonally inwards, acting as a spacer and stiffener of the dihedron formed by the two parts.

3. The modular fence according to claim 1, wherein the front part has a considerably rectangular contour with the bottom projections forming said legs.

4. The modular fence according to claim 1, wherein the back part takes on an inverted isosceles trapezium shape forming the third leg with its bottom end.

5. The modular fence according to claim 1, wherein the front part incorporates on one of its side edges at least one resilient clamp projecting outwardly, in its own plane, and it incorporates on the edge opposite to the previously mentioned edge a considerably elongated vertical bar separated from the part itself by means of suitably distributed spacers, such that the clamps of one fence can be snapped onto the bar of the contiguous fence.

6. The modular fence according to claim 5, wherein said clamp comprises two arms defining a housing with a tapered opening, a longitudinally slotted housing in the clamp itself so as to allow varying the angle between fences or modules on uneven terrains as well as to complementarily allow an offsetting of height of adjacent fences.

7. The modular fence according to claim 1, wherein arranged on the front part next to its top crosspiece there is at least one housing provided with at least one small port in which there is arranged at least one lighting device controlled by an electronic board.

8. The modular fence according to claim 7, wherein said lighting device consists of at least one LED.

9. The modular fence according to claim 7, wherein said lighting device is fed by at least one battery.

10. The modular fence according to claim 9, wherein the battery is arranged in said housing.

11. The modular fence according to claim 7, wherein said lighting device incorporates a sensor for detecting the suitability of the existing ambient light.

12. The modular fence according to claim 1, wherein the legs of the front part incorporate external projections on their bottom end enhancing the stability of the fence against wind stresses.

13. The modular fence according to claim 1, wherein both parts have a mesh structure on their surface with large ports for the passage of air.

14. The modular fence according to claim 1, wherein both parts have a horizontal projection on their outer surface running along the surface from one side to the other.

15. The modular fence according to claim 1, wherein its parts are obtained by means of injection molding.

16. The modular fence according to claim 1, wherein its parts are made of a plastic material.
